(19) United States
(12) Patent Application Publication
(10) Pub. No.: US 2014/0041465 A1
(43) Pub. Date: Feb. 13, 2014

(54) Equipment test method and associated test tool and test system

(71) Applicant: Airbus Operations (SAS), Toulouse (FR)

(72) Inventors: Bertrand Crouzet, Toulouse (FR); Pascal Maurere, Fabas (FR)

(21) Appl. No.: 13/960,499

(22) Filed: Aug. 6, 2013

(30) Foreign Application Priority Data
Aug. 9, 2012 (FR) 1257723

(51) Int. Cl. G01M 99/00

(52) U.S. Cl. CPC G01M 99/00
USPC 73/865.9

(57) ABSTRACT

A method for testing electronic equipment, comprising at least a first board and a second board connected to each other, the method being controlled by means of a test tool external to the equipment. The method includes the steps of transmitting an acquisition command from the test tool to the first board, the first board comprising at least one input, on receipt of the acquisition command by the first board, triggering the acquisition of the signals present on the input, transmitting a generation command from the test tool to the second board, the second board comprising at least one output connected to the input, on receipt of the generation command by the second board, triggering of the generation on the output of signals to the input, receiving the signals by the first board; and transmitting from the first board to the test tool data about the signals received.

### CROSS-REFERENCES TO RELATED APPLICATIONS

This application claims the benefit of the French patent application No. 1257723 filed on Aug. 9, 2012, the entire disclosures of which are incorporated herein by way of reference.

### BACKGROUND OF THE INVENTION

The invention relates to a method for testing an equipment, together with an associated testing tool and test system.

When the testing of the operation and physical behaviour of electronic boards within equipment by means of an integration test is sought, provision can be made for one of the boards, referred to as the “main board” in the remainder of the document, to comprise a test sequencer capable of organising and running the test by sending appropriate commands to the other electronic boards.

The term “integration test” is used when it is necessary to test the interaction between the boards in terms of both their communication and their behaviour, under operating conditions as representative of nominal operation as possible. This involves high levels of activity of all of the internal and above all external resources (Input/Outputs) of each board to be tested. As the possible interactions are internal to the equipment (communication links not accessible from outside, electromagnetic and thermal radiation due to the proximity of the boards, arrangement of the mechanical components in relation to vibrations and impacts, etc.), it is not possible to replace a board with a test tool as the equipment is no longer representative if it is incomplete.

In this context, the role of a test tool, which cannot be directly embedded in the equipment instead of a board and is therefore external, is limited to initiating the test (by sending a corresponding instruction to the test sequencer of the main board) and receiving, for their possible observation, the signals generated by the various boards. The main board must independently manage the synchronisation of all of the boards, ensure the satisfactory performance of the test and centralise all of the results to provide them to the external test tool.

This solution is not however suitable when a large number of boards is used, supplied moreover by different manufacturers, while it remains necessary to check the joint operation of all of the boards, this check generally being carried out by the assembler of the equipment containing the boards (which is often not the manufacturer of the boards).

Thus for example, the use of the solution set out above requires that the assembler of the boards specifies and explains to the manufacturer of the main board (incorporating the test sequencer) the various tests to be performed, which involve knowledge of the other boards. This solution thus quickly becomes complex if a number of parties are involved as mentioned above, and if the configuration of the equipment in terms of type and number of boards is not strictly set.

### SUMMARY OF THE INVENTION

In this context, the invention proposes a method for testing an electronic equipment (aimed in particular at testing the physical behaviour of said equipment) comprising at least a first board and a second board connected to each other (generally directly, and therefore without the possibility of inserting measuring or signal injection tools without modifying the physical behaviour to be tested), the method being controlled using a test tool external to the equipment, characterised by the following steps:
transmission of an acquisition command (for example cyclical) from the test tool to the first board, which comprises at least one input;
on receipt of the acquisition command by the first board, triggering of an acquisition (for example cyclical) of the signals present on said input;
transmission of a generation command (for example cyclical) from the test tool to the second board, said second board comprising at least one output connected to said input;
on receipt of the generation command by the second board, triggering of a generation (for example cyclical) on said output of signals to said input;
receipt (for example periodical) of the signals by the first board;
transmission (for example periodical) from the first board to the test tool of data about the signals received.

The test tool thus triggers the operation and an exchange of signals between the first and second boards that are close to normal operating conditions. As explained below, by reiterating this process for the different boards in the equipment and the interfaces between said boards, an effective test is obtained on the equipment. It can thus be envisaged that the steps set out above be repeated for a plurality of inter-board links of the equipment (that is, input-output pairs internal to the equipment), and even for all of said inter-board links.

In practice, provision can be made for the first board to comprise an acquisition module that processes said received signals and stores the data produced by said processing.

Furthermore, the data about the signal received are data describing the signal received, which makes it possible to transmit a description of the signal in question to the test tool. The test tool can thus for example analyse said signal or display it to the user.

Provision can be made for the data about the signal received to be transmitted periodically. In a variant, the data about the signal received could be transmitted on receipt, by the first board, of a dedicated command from the test tool.

The test tool can in practice comprise an organising module capable of transmitting the acquisition and generation commands. The organising module can in this case control a plurality of interfaces (that is, inputs and outputs) located on a plurality of boards in the equipment.

At least one of said boards has a plurality of interfaces (that is, several inputs and/or outputs) and is capable of simultaneously processing a plurality of cyclical acquisition and generation commands received in relation to the interfaces of said plurality. This can apply to all of the boards in the equipment, in which case a particularly effective simulation is obtained for the equipment as a whole.

The invention also proposes a tool for testing an equipment comprising at least a first board and a second board, characterised in that it comprises an organising module capable of transmitting an acquisition command to the first board and capable of transmitting a generation command to the second board, the test tool being capable of receiving, from the first board, data about a signal generated, on receipt of the generation command, by the second board and received by the first board.

A test system is thus proposed comprising such a testing tool and said equipment.

### BRIEF DESCRIPTION OF THE DRAWINGS

Further features and advantages of the invention will become more apparent on reading the following description, given with reference to the attached drawings, in which:

FIG. 1 shows an example (simplified to facilitate understanding) of the context in which the invention is implemented;

FIG. 2 shows steps implemented during a test implemented in the context in FIG. 1.

### DETAILED DESCRIPTION OF THE PREFERRED EMBODIMENTS

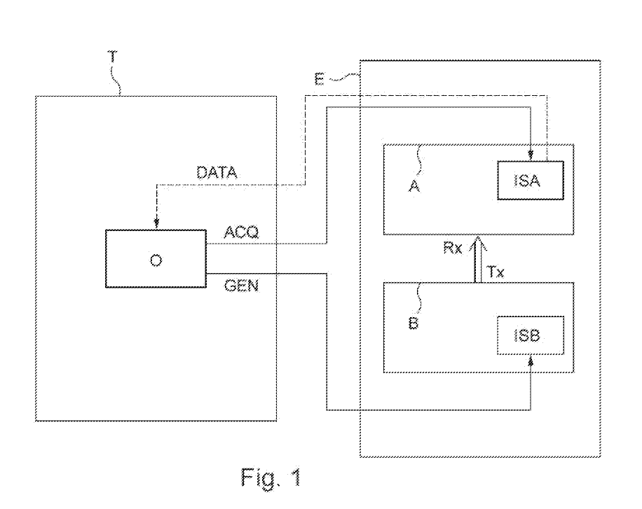

FIG. 1 shows an item of equipment E (for example a switch box or cabinet) that receives a plurality of electronic boards, here an electronic board A and an electronic board B.

The equipment E may of course contain other electronic boards, and many more links between boards.

Each electronic board A, B is intended to perform a function of the system in which the equipment E is located; they are for example calculator modules used in an aviation system.

Each electronic board A, B is for example designed around a microprocessor and generates output signals as a function of input signals that it receives, on the basis of processing determined for example as a function of the running of a computer program, stored in a memory of the electronic board, by the microprocessor.

In FIG. 1, it is proposed to implement a physical integration test of the equipment E using a test tool T; this is to check the joint satisfactory operation, in an electrical, electronic, mechanical and thermal sense, of the various electronic boards A, B assembled within the equipment E.

As a result, integration software (ISA, ISB respectively) is used within each of the electronic boards A, B, stored in the electronic board in question and run by the microprocessor of the board in question during the integration test.

In order to complete the integration test successfully, the test tool T comprises a test organising module O that generates in particular instructions or commands for the various electronic boards A, B of the equipment E, as explained below.

The organising module O is for example also designed with microprocessor architecture and can exchange data with the electronic boards A, B, particularly the aforementioned commands, through a local computer network, for example of the RS485 type (which can be used at high bit rates, for example 10 Mbps).

Although not shown for reasons of concision, the test tool T can also receive the output signals generated by the various electronic boards A, B in order, for example, to measure one of said signals or display a representation of one of said signals on a display device intended for a user.

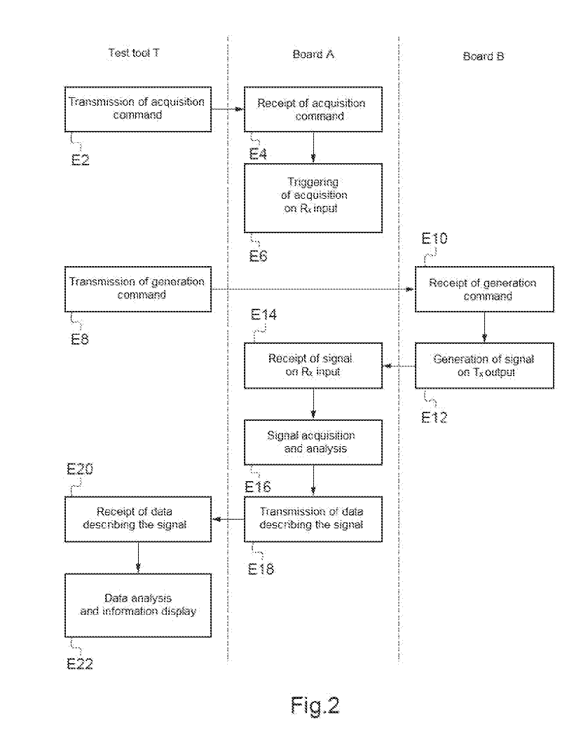

FIG. 2 shows an example of a method implemented through the cooperation of the elements described above in order to perform an integration test.

This method starts at a step E2 with the transmission by the organising module 0 of the test tool T, of an acquisition command ACQ to the electronic board A. This command is carried in the example described here by the local computer network, as already mentioned.

The acquisition command ACQ is received in step E4 by the electronic board A.

On receipt of the acquisition command, the integration software ISA, embedded in the electronic board A (and run by the microprocessor of said electronic board A) triggers a process for the acquisition of any signals received on an input Rx of the electronic board A (step E6). This is, for example, a cyclical acquisition process.

Said acquisition is for example implemented by a dedicated acquisition module on the electronic board A, which typically performs an analogue-digital conversion of the signals measured on the input Rx and stores the data representing the signal produced by appropriate processing.

While the acquisition is taking place, the organising module O of the test tool T transmits, in step E8, a generation command GEN to the electronic board B.

The generation command GEN is received in step E10 by the electronic board B.

On receipt of said command, in step E12 the board B (implementing processing controlled by the integration software ISB) generates a signal (for example with a particular form optionally determined by parameters associated with the generation command GEN received) on its output Tx, connected according to the design of the equipment E to the input Rx of the electronic board A.

Provision is made here for the cyclical generation of a signal with a predetermined form, which makes it possible to generate continuously (but relatively simply) a signal that will simulate the behaviour of the output Tx in normal operation.

If the electronic boards A, B of the equipment E are correctly assembled, the signal is received in step E14 on the input Rx and acquired by the electronic board A, then analysed, in step E16. If cyclical generation is used as described above, a given signal will be received periodically.

The data from the processing implemented by the electronic board A, which describe the signal generated by the board B, are transmitted in step E18 to the test tool T (for example, to the organising module O linked to the electronic board A by the local computer network).

Provision can be made, for example, for said data to be transmitted periodically on the acquisition triggered in step E6 (which makes it possible to regularly empty the memory used to store the data describing the signal acquired). In a variant, the descriptive data DATA could be transmitted on receipt of a new specific command from the organising module O to the electronic board A.

The data describing the signal, transmitted by the electronic board A, are received in step E20 by the test tool T, for example by its organising module O.

In step E22, the test tool T can thus perform an analysis of the data received, for example to check that they match the data expected. Furthermore, information for the user based on the descriptive data received, such as for example a curve representing the signal generated by the board B and received by the board A, or an indication of the satisfactory joint operation of the electronic boards A and B, if said satisfactory operation results from the aforementioned check, can be displayed on the display device (not shown) of the test tool T.

More generally, by controlling all of the boards in the equipment, the test tool can simultaneously stimulate all of the links between the boards present, reflecting the operation previously described between the boards A and B.

The example described above is merely one possible, non-limitative embodiment of the invention.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A method for testing an electronic equipment comprising at least a first board and a second board connected to each other, the method being controlled by means of a test tool external to the equipment, comprising the following steps:
transmitting an acquisition command from the test tool to the first board, said first board comprising at least one input;
on receipt of the acquisition command by the first board, triggering an acquisition of the signals present on said input;
transmitting a generation command from the test tool to the second board, said second board comprising at least one output connected to said input;
on receipt of the generation command by the second board, triggering a generation on said output of signals to said input;
receiving the signals by the first board;
transmitting data about the signals received from the first board to the test tool.

2. The testing method according to claim 1, wherein an acquisition module processes said received signals and stores the data produced by said processing.

3. The testing method according to claim 1, wherein the data about the signal received are data describing the signal received.

4. The testing method according to claim 1, wherein the data about the signal received are transmitted periodically.

5. The testing method according to claim 1, wherein the data about the signal received are transmitted on receipt, by the first board, of a dedicated command from the test tool.

6. The testing method according to claim 1, wherein the test tool comprises an organising module, the acquisition and generation commands being transmitted by the organising module.

7. The testing method according to claim 6, wherein the organising module controls a plurality of interfaces located on a plurality of boards in the equipment.

8. The testing method according to claim 1, wherein at least one board has a plurality of interfaces and is capable of simultaneously processing a plurality of cyclical acquisition and generation commands received in relation to the interfaces of said plurality.

9. The testing method according to claim 1, wherein the generation of signals on said output is a cyclical generation of signals on said output.

10. The testing method according to claim 1, wherein the acquisition of the signals on said input is a cyclical acquisition of the signals present on said input.

11. The testing method according to claim 1, wherein the receipt of the signals by the first board is a periodic receipt of the signals by the first board.

12. A tool for testing an equipment comprising at least a first board and a second board, wherein the tool comprises an organising module configured to transmit an acquisition command to the first board and configured to transmit a generation command to the second board, the test tool being configured to receive, from the first board, data about a signal generated, on receipt of the generation command, by the second board and received by the first board.

13. A test system comprising a testing tool according to claim 12 and said equipment.
